(19) United States
(12) Patent Application Publication
(10) Pub. No.: US 2009/0221091 A1
(43) Pub. Date: Sep. 3, 2009

(54) CHEMICAL REACTION CARTRIDGE, MIXTURE GENERATING METHOD AND CONTROL DEVICE OF CHEMICAL REACTION CARTRIDGE

(75) Inventors: Takeyuki Mogi, Musashino-shi (JP); Takeo Tanaami, Musashino-shi (JP)

Correspondence Address: SUGHRUE MION, PLLC, 2100 PENNSYLVANIA AVENUE, N.W., SUITE 800, WASHINGTON, DC, 20037, US

(73) Assignee: Yokogawa Electric Corporation, Tokyo (JP)

(21) Appl. No.: 12/396,148

(22) Filed: Mar. 2, 2009

(30) Foreign Application Priority Data
Mar. 3, 2008 (JP) 2008-052097

(51) Int. Cl. G01N 21/00; B01J 19/00; G01N 1/00

(52) U.S. Cl. 436/174; 422/68.1; 422/82.05

(57) ABSTRACT

Disclosed is a chemical reaction cartridge including an elastic body as a construction material and a flow path and two or more chambers connected by the flow path formed inside the cartridge, and the cartridge is structured so as to move or block a fluid substance in the flow path or the chambers by partially sealing the flow path, the chambers or both the flow path and the chambers by applying external force to the elastic body from outside, as the chambers, the cartridge has two or more mixing chambers each of which is to contain a mixture in a fluid state and the cartridge has two or more ingredient chambers provided for each of the mixing chambers by being connected with the flow path, in each of which an ingredient of the mixture divided in an amount according to a mixing ratio is to be contained.

### BACKGROUND OF THE INVENTION

1. Field of the Invention

The present invention relates to a generation of two or more mixtures by using a chemical reaction cartridge.

2. Description of Related Art

In JP2005-037368 and JP2005-313065, chemical reaction cartridges in which chambers and flow path are formed inside thereof and which are structured with an elastic body which can move and block the fluid in the chambers and the flow paths and a rigid substrate to maintain the position and the shape are suggested in order to carry out a synthesis, a dissolution, a detection, an isolation and the like of a solution according to a set protocol without individual variability, at low cost, safely and easily.

According to the inventions disclosed in JP2005-037368 and JP2005-313065, the chambers and the flow path are squeezed by deforming the elastic body by a roller or the like and the fluid is moved and blocked by moving or stopping the roller or the like in a state where the elastic body is squeezed.

Such chemical reaction cartridges are also used as a bio cartridge (bio-chip) for testing and analyzing DNA, RNA, protein and the like.

Here, a supplemental explanation will be given for the measuring of DNA content.

For example, as shown in FIG. 12, in order to quantitatively measure the DNA content included in a sample, a fixed amount of liquid mixture is obtained by mixing the sample DNA solution, the dilute solution and the intercalator solution by using pipettes, chips, microtubes, measuring tubes (cell, plate) and the like. After five minutes from the mixing, the fluorescence amount which is emitted from the liquid mixture is measured by the fluorescence reader. When the liquid mixture is made to sit still for five minutes, the intercalator enters into the double helix of the DNA and the fluorescence is emitted. The measurement by the fluorescence reader needs to be carried out promptly because the fluorescence fades out over time. In order to obtain the DNA content from the fluorescence amount, the fluorescence reader needs to be corrected by the standard DNA. The correction is carried out as follows.

As shown in FIG. 13B, the standard DNA solution a (μ1), the dilute solution b (μ1) and the intercalator solution c (μ1) are mixed to obtain liquid mixtures in same amount. The DNA concentration of the standard DNA solution is known. As shown in the table of FIG. 13A, assuming that a+b+c=(constant), number of types of liquid mixtures (dilution series) in which the mixing ratio of a:b is changed are obtained, and after five minutes, the fluorescence amounts which are emitted from the liquid mixtures are measured by the fluorescence reader. The calibration curve shown in FIG. 12C is obtained from the relation between the DNA concentrations and the measured fluorescence amounts. By using the calibration curve, the DNA concentration of the liquid mixture in which the sample DNA solution is mixed can be obtained, and the DNA content can be obtained from the entire amount.

However, in the conventional chemical reaction cartridge, cartridges were needed for the number of liquid mixtures to be generated in order to generate two or more liquid mixture series, such as in case of generating dilution series.

### SUMMARY OF THE INVENTION

In view of the above problem of the prior art, the object of the present invention is to provide a chemical reaction cartridge in which two or more mixtures can be generated, a mixture generating method which uses the chemical reaction cartridge and the control device of the chemical reaction cartridge.

In order to solve the above problem, according to a first aspect of the present invention, there is provided a chemical reaction cartridge comprising an elastic body as a construction material and a flow path and two or more chambers connected by the flow path formed inside the cartridge, and the cartridge is structured so as to move or block a fluid substance in the flow path or the chambers by partially sealing the flow path, the chambers or both the flow path and the chambers by applying external force to the elastic body from outside, and as the chambers, the cartridge has two or more mixing chambers each of which is to contain a mixture in a fluid state, and the cartridge has two or more ingredient chambers provided for each of the mixing chambers by being connected with the flow path, in each of which an ingredient of the mixture divided in an amount according to a mixing ratio is to be contained.

According to a second aspect of the present invention, there is provided a chemical reaction cartridge comprising an elastic body as a construction material and a flow path and two or more chambers connected by the flow path formed inside the cartridge, and the cartridge is structured so as to move or block a fluid substance in the flow path or the chambers by partially sealing the flow path, the chambers or both of the flow path and the chambers by applying external force to the elastic body from outside, as the chambers, the cartridge has two or more mixing chambers each of which is to contain a mixture, the cartridge has two or more ingredient supplying chambers each of which is to contain an ingredient of the mixture to be distributed to the mixing chambers, the cartridge has an ingredient chamber and the flow path to be commonly used by two or more ingredients, which connect between the two or more mixing chambers and the two or more ingredient supplying chambers, and the ingredient of the mixture is divided in an amount according to a mixing ratio and is to be contained in the ingredient chamber.

According to a third aspect of the present invention, there is provided a mixture generating method using the chemical reaction cartridge comprising filling the ingredient in the amount according to the mixing ratio in each of the ingredient chambers and moving the ingredient in each of the two or more ingredient chambers to one of the mixing chambers by applying the external force to the elastic body to generate the mixture in which two or more ingredients are mixed, and the moving of the ingredient is carried out for the two or more mixing chambers.

According to a fourth aspect of the present invention, there is provided a mixture generating method using the chemical reaction cartridge comprising first moving the ingredient in the amount according to the mixing ratio from the ingredient supplying chamber to each of the ingredient chambers by shrinking the ingredient supplying chamber for the amount according to the mixing ratio by applying the external force to the elastic body and second moving the ingredient contained in each of the two or more ingredient chambers to one of the mixing chambers by applying the external force to the elastic body to generate the mixture in which two or more ingredients are mixed, and the second moving is carried out for the two or more mixing chamber.

According to a fifth aspect of the present invention, there is provided a mixture generating method using the chemical reaction cartridge comprising filling the ingredient in the amount according to the mixing ratio from the ingredient supplying chamber to each of the ingredient chambers at once by applying the external force to the elastic body and moving the ingredient contained in each of the two or more ingredient chambers to one of the mixing chambers by applying the external force to the elastic body to generate the mixture in which two or more ingredients are mixed, and the moving is carried out for the two or more mixing chambers and the chemical reaction cartridge in which a volume of each of the ingredient chambers is the amount according to the mixing ratio is used.

According to a sixth aspect of the present invention, there is provided a mixture generating method using the chemical reaction cartridge comprising first moving the ingredient in the amount according to the mixing ratio from the ingredient supplying chambers to each of the ingredient chambers by applying the external force to the elastic body by carrying out a time division for each ingredient and second moving the ingredient contained in each of the two or more ingredient chambers to each of the mixing chambers by applying the external force to the elastic body to generate a mixture in which two or more ingredients are mixed in each of the mixing chambers.

According to a seventh aspect of the present invention, there is provided a control device of a chemical reaction cartridge comprising the chemical reaction cartridge and pressing members for making the control device control a moving and a blocking of the liquid substance by applying the external force to the elastic body, and the pressing members are structured in a multiple-line structure where the pressing members move in a direction intersecting both of the two directions and are structured so as to move independently from other lines while maintaining a space between the pressing members for each line and the ingredient in the amount according to the mixing ratio is moved to each of the mixing chambers by moving the ingredient via the flow path which extend in each of the two directions by the pressing members.

According to the present invention, there is an advantage that two or more mixtures can be generated from each ingredient promptly, easily, safely and accurately by using one chemical reaction cartridge.

### BRIEF DESCRIPTION OF THE DRAWINGS

The above and other objects, advantages and features of the present invention will become more fully understood from the detailed description given hereinbelow and the appended drawings which are give by way of illustration only, and thus are not intended as a definition of the limits of the present invention, and wherein:

FIGS. 1A, 1B and 1C are plan layout views of a chemical reaction cartridge according to the first embodiment of the present invention;

FIG. 2 is a plan layout view of a chemical reaction cartridge according to the second embodiment of the present invention;

FIG. 3 is a cross-sectional structural diagram of the chemical reaction cartridge according to the second embodiment of the present invention;

FIGS. 4A and 4B are cross-sectional structural diagrams of a chemical reaction cartridge according to the third embodiment of the present invention;

FIG. 5 is a plan layout view of a chemical reaction cartridge and a group of rollers according to the fourth embodiment of the present invention;

FIGS. 6A to 6F are process diagrams according to the fourth embodiment of the present invention;

FIGS. 7A to 7F are process diagrams according to the fourth embodiment of the present invention which are continuation of FIGS. 6A to 6F;

FIGS. 8A to 8F are process diagrams according to the fourth embodiment of the present invention which are continuation of FIGS. 7A to 7F;

FIGS. 9A to 9F are process diagrams according to the fourth embodiment of the present invention which are continuation of FIGS. 8A to 8F;

FIGS. 10A to 10F are process diagrams according to the fourth embodiment of the present invention which are continuation of FIGS. 9A to 9F;

FIGS. 11A and 11B are process diagrams according to the fourth embodiment of the present invention which are continuation of FIGS. 10A to 10F;

FIG. 12 is an explanatory diagram illustrating a conventional method to measure a DNA content of an unknown sample; and

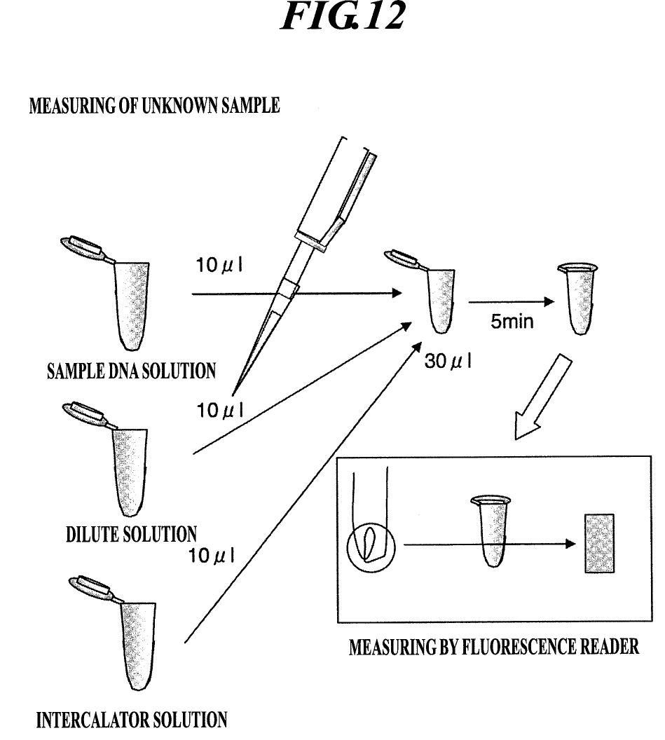

FIGS. 13A, 13B and 13C are explanatory diagrams illustrating a conventional correction method by a standard DNA.

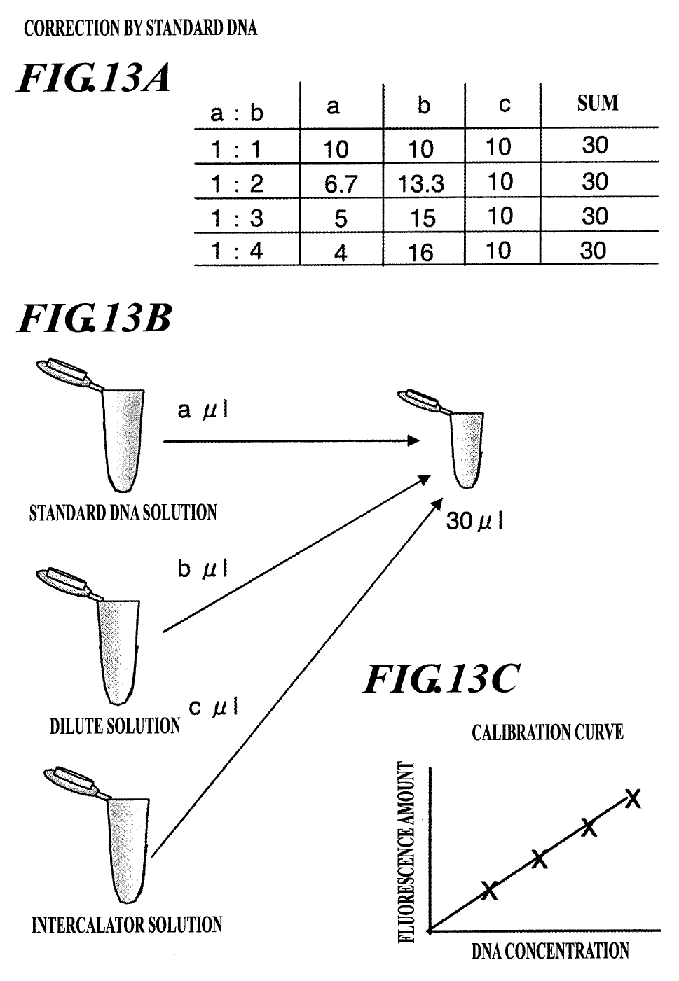

### DESCRIPTION OF THE PREFERRED EMBODIMENTS

Hereinafter, embodiments of the present invention will be described with reference to the drawings. Each of the followings is one embodiment of the present invention and does not limit the scope of the present invention. Here, the chemical reaction cartridge of the present invention belongs to an area where the chemical reaction cartridge is applied as a reaction device generally called “micro reactor”. The present invention is not limited to a specific usage.

### First Embodiment

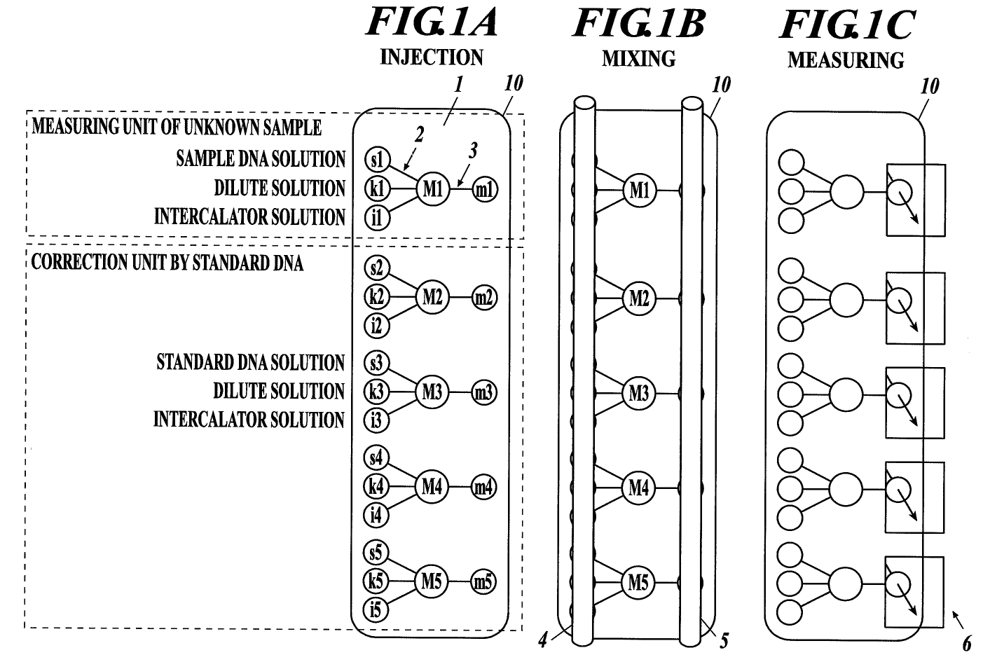

First, the first embodiment of the present invention will be described with reference to FIG. 1.

Each of FIGS. 1A, 1B and 1C is a plan layout view of a chemical reaction cartridge according to the first embodiment of the present invention.

As shown in FIGS. 1A, 1B and 1C, the chemical reaction cartridge 10 is formed of an elastic body 1 which is made of rubber or the like having air-tightness and elasticity and a rigid substrate (omitted from the drawings) which is formed with a hard material and which is disposed at a back surface for positioning and maintaining the shape.

As for a material of the elastic body 1, silicon rubber, PDMS (polydimethylsiloxane), natural rubber and polymers thereof, acrylic rubber, urethane rubber or the like is used.

As for a material of the substrate, glass, metal, hard resin or a rigid body which can be bent is used.

Concave portions are formed on the inner surface of the elastic body 1. The flow paths 2 and 3 and the chambers s1 to s5, k1 to k5, i1 to i5, M1 to M5 and m1 to m5 are formed by the surface of the elastic body 1 in which the concave portions are formed excluding the concave portions being adhesively joined by adhesion, welding or the like to the surface of the substrate. The chambers are constituted of the ingredient chambers s1 to s5, k1 to k5, i1 to i5, mixing chambers M1 to M5 and mixing auxiliary chambers m1 to m5. The flow paths connect between the chambers and allow a substance to move between the chambers. The substance to be moved is a substance having flowablility, a liquid or other substance in a fluid state. When the reactive substance to be moved is a substance which does not flow such as a solid substance or the like or is a substance which is difficult to flow, a solution including the reactive substance is put in the chamber.

The flow paths and the chambers may be formed so that the elastic body covering the entire flow paths and chambers or a partial wall portion of the flow paths and the chambers may be constituted with an elastic body. By inserting one more layer of an elastic body between the substrate and the elastic body 1, the flow paths and the chambers can be formed so that the elastic body covers the entire flow paths and chambers. Further, an elastic body can be used instead of the substrate and the flow paths and the chambers may be constituted without a rigid substrate.

Moving of the substance is carried out as described below.

First, a pressing unit such as a roller, a squeegee, a syringe or the like is pressed against the elastic body 1 above the flow paths or the chambers to squeeze the flow paths or the chambers. By squeezing the flow paths or the chambers, the substance inside the flow paths or the chambers are made to flow and move. Further, by moving the pressing position, the substances inside the flow paths or the chambers are made to flow and the substances are made to move in the moving direction of the pressing position. The moving of the pressing position is preferred to be carried out in a condition where the inner spaces of the flow paths or the chambers are pressed to the point where the inner spaces are sealed by making the opposed inner walls of the flow paths or the chambers contact each other at the pressing position.

The substances are prevented from moving by sealing the inner spaces of the flow paths or the chambers by making the opposed inner walls of the flow paths or the chambers contact each other by the pressing unit. By using a plurality of pressing units, the substances can be moved by one of the pressing units, and at the same time, another pressing unit can press the flow paths or the chambers at a position further in the moving position to prevent the substances from moving further than the pressing position of the another pressing unit.

Based on the above description, the moving and blocking of the substances in the cartridge 10 are controlled.

According to the above principal, moving of the substances in the cartridge 10 is controlled to carry out the operation for a chemical reaction. The embodiment is an example where the cartridge is applied for measuring the DNA content. Further, in the embodiment, rollers 4 and 5 are used as the pressing units. The flow paths 2 and 3 and the chambers s1 to s5, k1 to k5, i1 to i5, M1 to M5 and m1 to m5 are in a state where the volumes are zero due to the inner walls being adhered to each other before the solution is introduced.

A sample DNA solution is injected in the ingredient chamber s1. A standard DNA solution is injected in the ingredient chambers s2 to s5. A dilute solution is injected in the ingredient chambers k1 to k5. An intercalator solution is injected in the ingredient chambers i1 to i5. The injection is carried out by puncturing an injection needle in the elastic body 1 which covers the ingredient chambers. After the injection, the hole will be closed by an elasticity of the elastic body 1 when the injection needle is pulled out. An example of filling amounts of each ingredient chambers is shown in Table 1.

TABLE 1

| | s | k | i |
|---|---|---|---|
| 1 | 10 | 10 | 10 |
| 2 | 10 | 10 | 10 |
| 3 | 6.7 | 13.3 | 10 |
| 4 | 5 | 15 | 10 |
| 5 | 4 | 16 | 10 |

(unit μl)

According to Table 1, 5 μl of the standard DNA solution is filled in the ingredient chamber s4, 15 μl of the dilute solution is filled in the ingredient chamber k4 and 10 μl of the standard DNA solution is filled in the ingredient chamber i4. As shown in Table 1, the ingredient in an amount according to each mixing ratio is injected in each of the ingredient chambers. The total volume of the ingredient chambers s, k and i which are connected to one of the mixing chambers M is constant for each of the mixing chambers M1 to M5, the volume is 30 l in the example.

The volume of each ingredient chamber unit is determined, and the ingredient chamber s4 is formed so as to have a volume of 5 μl. That is, when the ingredient chamber s4 is fully filled with the solution, 5 μl of the solution is to be filled. In such way, each ingredient chamber has a metrological function, and the mixing amount of each ingredient is the volume of the ingredient chamber.

The volume of a single ingredient chamber differs according to the mixing chamber as shown in Table 1 in order to change the mixing ratio for each liquid mixture. However, the volumes of the ingredient chambers s1, k1 and i1 and the ingredient chambers s2, k2 and i2 are the same.

Five mixing chambers which are the mixing chambers M1 to M5 are provided. The ingredient chambers s, k and i are provided for each of the mixing chambers M and they are respectively connected to each of the mixing chambers M by the flow paths 2, 2 and 2. Further, as described above, the ingredient of the mixture is divided in an amount according to the mixing ratio and is filled in the ingredient chambers s, k and i. The mixing auxiliary chambers m in the downstream are respectively connected to each of the mixing chambers M by the flow paths 3, the mixing auxiliary chambers are supplementary provided and the mixing auxiliary chambers m are also the chambers which are targeted for fluorescence detection.

After all of each ingredients are injected in each of the ingredient chambers s1, k1, i1 to s5, k5, i5, the ingredient chambers s1, k1, i1 to s5, k5, i5 are pressed by the roller 4 from the end portion which is in the opposite side of the flow paths 2 as shown in FIG. 1B to move each ingredient to the flow paths 2 side. Then, the above three ingredients are moved to each of the mixing chambers M1 to M5 (in the direction from left to right in the drawing) and they are mixed. The time when a measurement is carried out by the fluorescence reader is determined to be five minutes after the time when the ingredients are mixed in the mixing chamber M that is when the good expression level of fluorescence appears. During the five minutes, the mixtures are moved back and forth between the mixing chambers M and the mixing auxiliary chambers m by the roller 4 and the roller 5 to facilitate the mixing.

Facilitation of the mixing may be carried out by transmitting vibration to the mixtures which are contained in the mixing chambers M. In such case, the flow paths 3 and the mixing auxiliary chambers m are not necessarily needed, and it is sufficient that the mixing chambers M are made to be the chambers targeted for the fluorescence detection. The vibration may be transmitted by pressing the roller 4 on the elastic body 1 and vibrating or may be transmitted by using an actuator such as oscillator using electromagnetic power or the like.

Just after 5 minutes from the time when the ingredients are mixed in the mixing chambers M, the fluorescence amount of the mixtures which are contained in the mixing auxiliary chambers m1 to m5 are measured by the fluorescence reader 6 as shown in FIG. 1C. In a similar manner as the above described prior art, the measured values obtained by measuring the mixing auxiliary chambers m2 to m5 as targets are used as the correction information, and the DNA content of a sample is calculated based on the measured value obtained by measuring the mixing auxiliary chamber m1 as a target.

### Second Embodiment

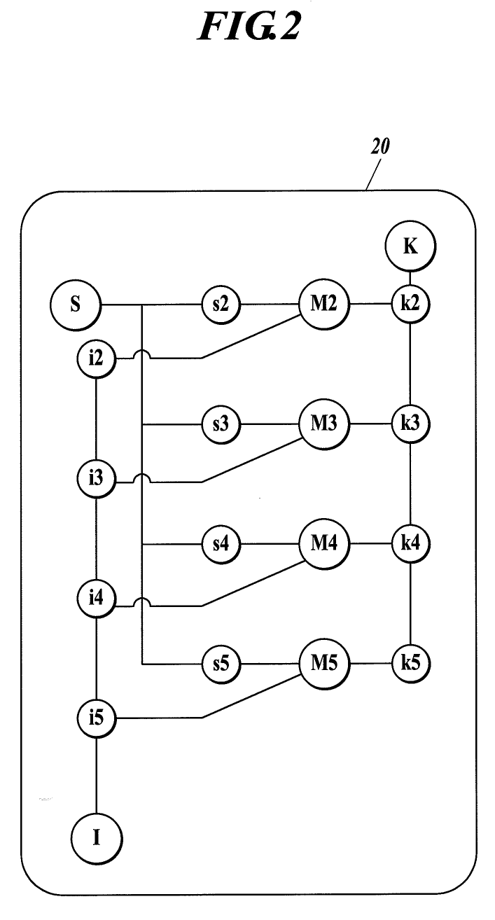

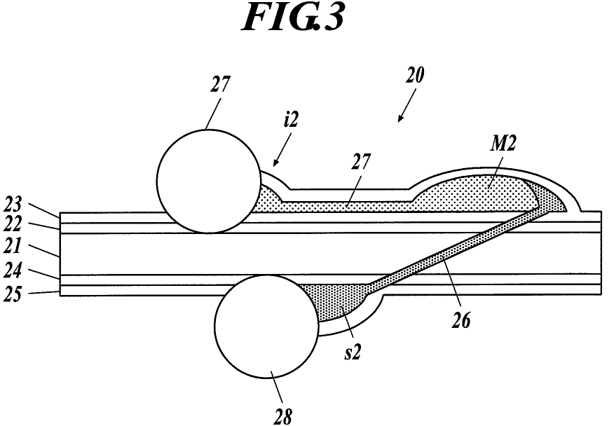

Next, the second embodiment of the present invention will be described with reference to FIGS. 2 and 3. FIG. 2 is a plan layout view of a chemical reaction cartridge according to the second embodiment of the present invention. FIG. 3 is a cross-sectional structural diagram of the chemical reaction cartridge according to the second embodiment of the present invention.

In the above described first embodiment, the same ingredient needs to be separated and divided in the number according to the number of liquid mixtures to be generated. In order to solve this problem, the chemical reaction cartridge 20 according to the embodiment comprises an ingredient supplying chamber (for example, S) which is connected to one of the ingredient chambers (for example, s2) belonging to one of the mixing chambers (for example, M2) and is connected to another of the ingredient chambers (for example, s3) belonging to another of the mixing chambers (for example, M3). The ingredient supplying chamber contains the ingredient to be distributed to the above ingredient chambers (for example, s2, s3).

The embodiment is an example where the correction unit by the standard DNA which includes s2, k2, i2 to s5, k5, i5 and M2 to M5 described in the above first embodiment is structured. The same symbols are used for the corresponding chambers.

In the cartridge 20, the ingredient supplying chamber S which is connected to the ingredient chambers s2 to s5 to which the standard DNA solution is to be distributed, the ingredient supplying chamber K which is connected to the ingredient chambers k2 to k5 to which the dilute solution is to be distributed and the ingredient supplying chamber I which is connected to the ingredient chambers i2 to i5 to which the intercalator solution is to be distributed are formed.

The ingredient supplying chambers I and K, the ingredient chambers k2, i2 to k5, i5, the mixing chambers M2 to M5 and the flow paths that connect between the above chambers are formed in the same surface side of the cartridge 20. The ingredient supplying chamber S, the ingredient chambers s2 to s5 and the flow paths that connect between the above chambers are formed in the opposite surface side of the cartridge 20. The cross-sectional structural diagram of the cartridge 20 is shown in FIG. 3. The flow paths between the ingredient chambers i2, i3, i4 and the mixing chambers M2, M3, M4 and the flow paths between the ingredient supplying chamber S and the ingredient chambers s3 to s5 are formed in the opposite surface side of the substrate from each other. Thereby, overhead crossing of the flow paths can be realized.

As shown in FIG. 3, the cartridge 20 comprises a rigid substrate 21, a base sheet 22 formed of an elastic body which is adhered on one surface of the substrate 21, a top sheet 23 formed of an elastic body which is partially adhered on the base sheet 22 to form the chambers and the flow path between the based sheet 22, a base sheet 24 formed of an elastic body which is adhered on the opposite surface of the substrate 21 and a top sheet 25 formed of an elastic body which is partially adhered on the base sheet 24 to form the chambers and the flow path between the base sheet 24.

The ingredient chamber s2 and the mixing chamber M2 are connected via the hole (flow path) 26 which penetrates the substrate 21, the base sheet 22 and the base sheet 24. The connection between the ingredient chamber s3 and the mixing chamber M3, the connection between the ingredient chamber s4 and the mixing chamber M4 and the connection between the ingredient chamber s5 and the mixing chamber M5 also have a similar structure.

In a similar way as the above described first embodiment, each of the ingredient chambers s2, k2, i2 to s5, k5, i5 has a metrological function and the volume of each ingredient chambers is the mixing amount of each ingredient.

In the ingredient supplying chambers S, K and I, the standard DNA solution, the dilute solution and the intercalator solution are respectively filled, in this order, in advance.

When the correction is to be carried out, first, the standard DNA solution is filled in each of the ingredient chambers s2 to s5 from the ingredient supplying chamber S at once by pressing the elastic body above the ingredient supplying chamber S by a roller. Each of the ingredient chambers s2 to s5 receives the standard DNA solution in an amount of the volume of each of the ingredient chambers, that is, in the amount according to the mixing ratio. At the same time, it is preferred that the dilute solution is filled in each of the ingredient chambers k2 to k5 from the ingredient supplying chamber K by pressing the elastic body above the ingredient supplying chamber K by a roller. Each of the ingredient chambers k2 to k5 receives the dilute solution in an amount of the volume of each of the ingredient chambers, that is, in the amount according to the mixing ratio. At the same time, it is preferred that the intercalator solution is filled in each of the ingredient chambers i2 to i5 from the ingredient supplying chamber I by pressing the elastic body above the ingredient supplying chamber I by a roller. Each of the ingredient chambers i2 to i5 receives the intercalator solution in an amount of the volume of each of the ingredient chambers, that is, in the amount according to the mixing ratio.

When the ingredient chambers s2 to s5 do not have the metrological function, the flow path between the ingredient supplying chamber S and the ingredient chamber s2 is made to be communicated and the flow paths between the ingredient supplying chamber S and the ingredient chambers s3 to s5 are blocked so that the ingredient in an amount according to the mixing ratio moves to the ingredient chamber s2 from the ingredient supplying chamber S by shrinking the ingredient supplying chamber S for the amount according to the mixing ratio of the ingredient which is to be contained in the ingredient chamber s2. The similar process is orderly carried out for the ingredient chambers s3 to s5 (in random order).

When the ingredient chambers k2 to k5 do not have the metrological function, the ingredient in the amount according to the mixing ratio is moved to the ingredient chamber k5 from the ingredient supplying chamber K by shrinking the ingredient supplying chamber K for the amount according to the mixing ratio of the ingredient which is to be contained in the ingredient chamber k5. The ingredient is orderly filled in the ingredient chamber k4, the ingredient chamber k3 and the ingredient chamber k2, in this order.

When the ingredient chambers i2 to i5 do not have the metrological function, the ingredient in the amount according to the mixing ratio is moved to the ingredient chamber i2 from the ingredient supplying chamber I by shrinking the ingredient supplying chamber I for the amount according to the mixing ratio of the ingredient which is to be contained in the ingredient chamber i2. The ingredient is filled orderly in the ingredient chamber i3, the ingredient chamber i4 and the ingredient chamber i5, in this order.

Next, each ingredient which are contained in each of the ingredient chambers s2, k2, i2 to s5, k5, i5 are respectively moved to each of the mixing chambers M2 to M5 to mix the above three ingredients by pressing the elastic body above each of the ingredient chambers s2, k2, i2 to s5, k5, i5 by rollers (27, 28 or the like). The mixing is facilitated by an oscillator or the like, and the fluorescence amount is measured for the mixing chambers M2 to M5 which are targeted by the fluorescence reader just after 5 minutes.

### Third Embodiment

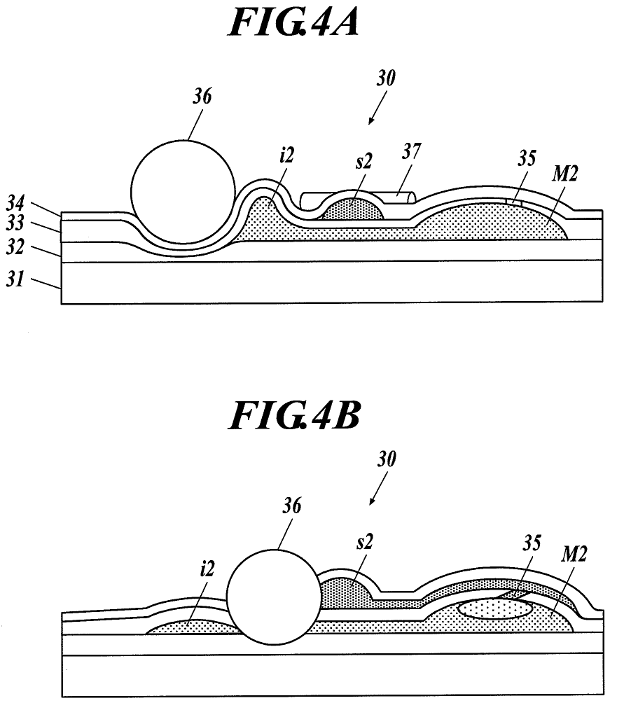

Next, the third embodiment of the present invention will be described with reference to FIG. 4. FIG. 4 is a cross-sectional structural diagram of a chemical reaction cartridge according to the third embodiment of the present invention. In the embodiment, the cross-sectional structure to realize the overhead crossing of the flow paths is modified comparing to the second embodiment, and the plan layout and other structures are similar to that of the above described second embodiment.

As shown in FIG. 4, the cartridge 30 of the embodiment comprises a rigid substrate 31, a base sheet 32 formed of an elastic body which is adhered on one surface of the substrate 31, an intermediate sheet 33 formed of an elastic body which partially adheres on the base sheet 32 to form the chambers and the flow path between the base sheet 32 and a top sheet 34 formed of an elastic body which partially adheres on the intermediate sheet 33 to form the chambers and the flow path between the intermediate sheet 33.

The ingredient supplying chambers I and K, the ingredient chambers k2, i2 to k5, i5, the mixing chambers M2 to M5 and the flow paths that connects the above chambers are formed between the base sheet 32 and the intermediate sheet 33. The ingredient supplying chamber S, the ingredient chambers s2 to s5 and the flow paths that connect the above chambers are formed between the intermediate sheet 33 and the top sheet 34. By forming the flow paths which connect between the ingredient chambers i2, i3, i4 and the mixing chambers M2, M3, M4 and the flow paths which connect between the ingredient supplying chamber S and the ingredient chambers s3 to s5 in different layers, the overhead crossing of the flow paths can be realized.

The ingredient chamber s2 and the mixing chamber M2 are connected via the hole (flow path) 35 which penetrates the intermediate sheet 33. The connection between the ingredient chamber s3 and the mixing chamber M3, the connection between the ingredient chamber s4 and the mixing chamber M4 and the connection between the ingredient chamber s5 and the mixing chamber M5 also have a similar structure. As shown in FIG. 4, in the embodiment, the hole 35 is provided at a portion of the intermediate sheet 33 which covers the mixing chamber M. However, alternatively, the intermediate sheet 33 itself in the mixing chamber M may be the hole, that is the structure may be in which that the intermediate sheet 33 is made to be missing in the mixing chamber M. In the later case, the upper surface and the lower surface of the mixing chamber M are respectively formed by the base sheet 32 and the top sheet 34.

Each ingredient is filled in the mixing chambers M2 to MS from each of the ingredient chambers s2, k2, i2 to s5, k5, i5 by the rollers 36 and 37 or the like, and other processes are carried out in a similar manner as in the above described second embodiment. In the above described second embodiment, supplying of the ingredient needed to be controlled by pressing the rollers against both sides of the cartridge. However, in the embodiment, supplying of the ingredient can be controlled by pressing the roller only on one surface of the cartridge.

### Fourth Embodiment

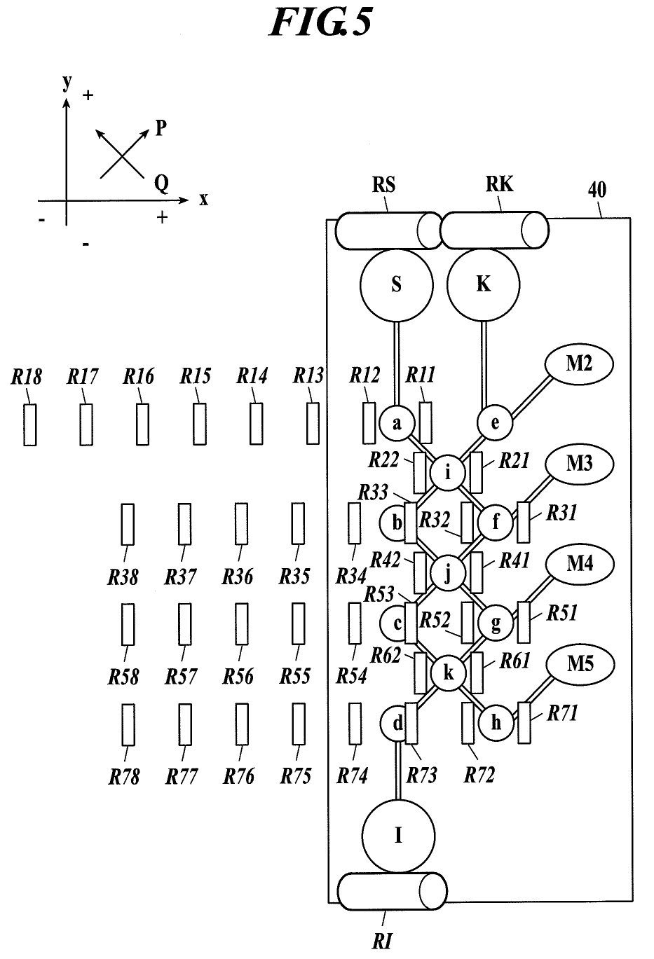

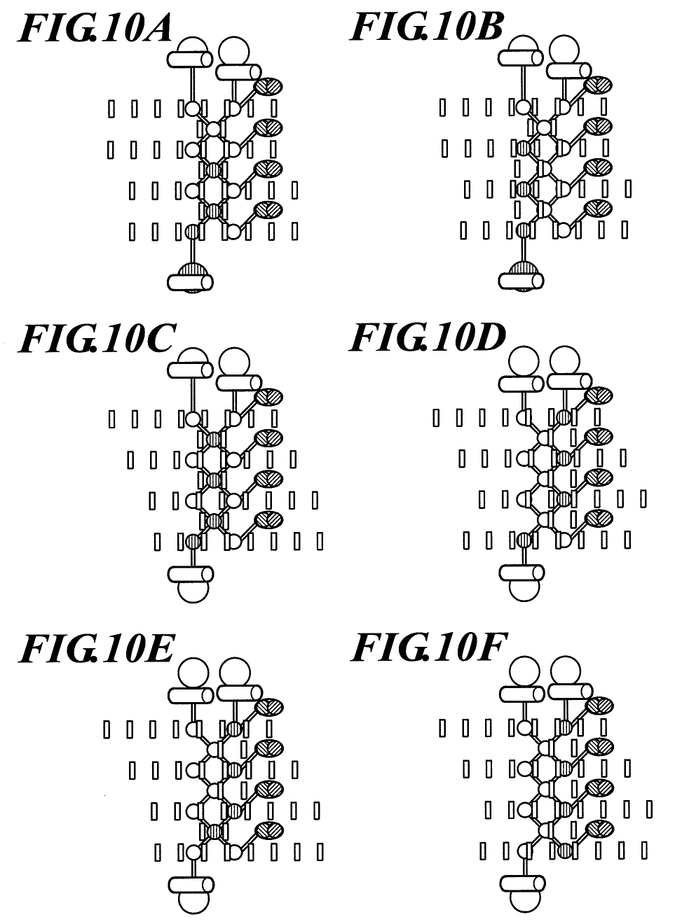

Next, the fourth embodiment of the present invention will be described with reference to FIGS. 5 to 11B. FIG. 5 is a plan layout view of a chemical reaction cartridge and a group of rollers according to the fourth embodiment of the present invention. In the embodiment, the overhead crossing of the flow paths is not applied as opposed to the above described second embodiment, and the ingredient chambers and the flow paths which are commonly used by two or more ingredients are applied and the use of the chambers and the flow paths is time-divided for each ingredient to move.

As shown in FIG. 5, eleven ingredient chambers a to k, flow paths which connect the chambers, three ingredient supply chambers S, K and I and four mixing chambers M2 to MS are formed in the chemical reaction cartridge 40 of the embodiment. The cartridge 40 is used as the correction unit by the standard DNA in a similar way as in the above described second embodiment.

In FIG. 5, a plane X-Y coordinates is shown. Four ingredient chambers a to d and four ingredient chambers e to h are disposed so as to be equally spaced and parallel to each other in Y-direction. The spaces in X-direction and the spaces in Y-direction of the ingredient chambers a to h are made to be equal. One ingredient chamber i is disposed at a position which is on the intersection of the diagonal lines of the four ingredient chambers a, b, e and f which are disposed so as to be equally spaced. Further, the ingredient chamber i and each of the ingredient chambers a, b, e and f are connected with the flow paths which extend along the diagonal lines. The ingredient chambers j and k are disposed in a similar manner and are connected to the surrounding four ingredient chambers with the flow paths.

The minimum unit of the net-like common passage which includes the ingredient chambers a to k is structured by three ingredient chambers. For example, three ingredient chambers e, i, f and two flow paths which connect the chambers constitute the minimum unit. The two directions P and Q which intersect one another are shown in the X-Y coordinates. The ingredient chamber e and the ingredient chamber i are connected with a flow path which extends in the P direction, and the ingredient chamber i and the ingredient chamber f are connected with a flow path which extends in the Q direction. This constitutes the minimum unit, and the entirety is structured by laying out and connecting the necessary number of the minimum units so as to commonly use the ingredient chambers.

Three ingredient supplying chambers S, K and I and four mixing chambers M2 to M5 are disposed around the common passages. As shown in FIG. 5, the ingredient supplying chambers S, K and I are distributed and disposed at both sides in the Y direction of the common passage, and each of the ingredient supplying chambers S, K and I are respectively connected to each of the ingredient chambers a, e and d by the flow paths. The mixing chambers M2 to MS are disposed at one side in the X direction of the common passage, and each of the mixing chambers M2 to MS are respectively connected to each of the ingredient chambers e, f, g and h with the flow paths in the P direction (may be Q direction).

The control device which controls the moving and blocking of the fluid in the cartridge 40 comprises lines of rollers in the X direction.

As shown in FIG. 5, the eight rollers in the first roller line are indicated as R11 to R18 and the two rollers in the second roller line are indicated as R21 and R22. Further, the eight rollers in the third roller line are indicated as R31 to R38 and the two rollers in the fourth roller line are indicated as R41 and R42. Furthermore, the eight rollers in the fifth roller line are indicated as R51 to R58 and the two rollers in the sixth roller line are indicated as R61 and R62. The eight rollers in the seventh roller line are indicated as R71 to R78.

The rotation direction of the rollers in each of the lines of rollers is in the X direction, and the rollers are lined in one line by maintaining spaces in the X direction. The control device comprises seven roller lines which are the first roller line to the seventh roller line and controls the independent moving of each of the roller lines in the X direction.

The control device has a holding mechanism to hold the cartridge 40. The control device holds the cartridge 40 with respect to the rollers as shown in FIG. 5. At this time, the first roller line R11 to R18 is disposed at the same position as the ingredient chambers a and e with respect to the Y direction, the second roller line R21 and R22 is disposed at the same position as the ingredient chamber i with respect to the Y direction, the third roller line R31 to R38 is disposed at the same position as the ingredient chambers b and f with respect to the Y direction, the fourth roller line R41 and R42 is disposed at the same position as the ingredient chamber j with respect to the Y direction, the fifth roller line R51 to R58 is disposed at the same position as the ingredient chambers c and g with respect to the Y direction, the sixth roller line R61 and R62 is disposed at the same position as the ingredient chamber k with respect to the Y direction and the seventh roller line R71 to R78 is disposed at the same position as the ingredient chambers d and h with respect to the Y direction.

Moreover, the control device has the rollers RS, RK and RI each of which respectively presses the ingredient supplying chambers S, K and I. The rollers RS, RK and RI rotate in the Y direction. The control device controls the independent moving of the rollers RS, RK and RI in the Y direction.

The control device controls the moving and blocking of the fluid in the cartridge 40 by applying external force by pressing the elastic body at the upper surface of the cartridge 40 with the above rollers, and generates liquid mixtures in different mixing ratios by moving each of the ingredients which are contained in the ingredient supplying chambers to each of the mixing chambers in the amount according to the mixing ratio.

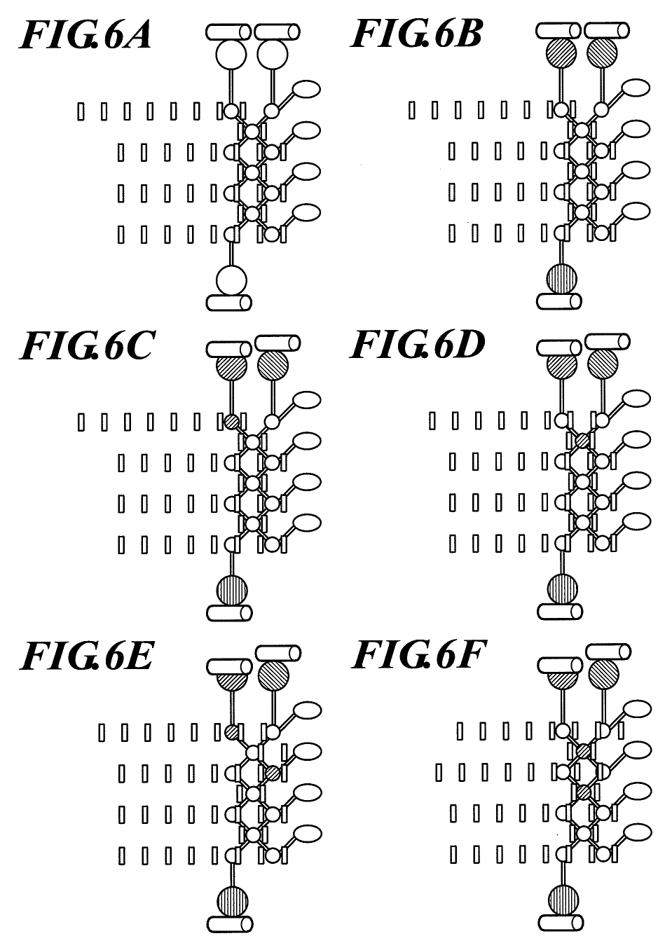

FIGS. 6A to 11B are process diagrams showing the entire process how the ingredient is distributed to each of the mixing chambers from the ingredient supplying chambers, and each unit has the same structure as FIG. 5.

The standard DNA solution is filled in the ingredient supplying chamber S, the dilute solution is filled in the ingredient supplying chamber K and the intercalator solution is filled in the ingredient supplying chamber I (FIG. 6B).

First, the ingredient supplying chamber S is squeezed for a predetermined amount by the roller RS and the standard DNA solution in an amount according to the mixing ratio is filled in the ingredient chamber a (FIG. 6C).

Next, the first roller line R11 to R18 is moved in the positive direction of the X-axis and the standard DNA solution in the ingredient chamber a is squeezed out by the roller R12 to be moved to the ingredient chamber i (FIG. 6D). At this time, other flow paths that connect to the ingredient chamber i are blocked by other rollers such as the rollers R21 and R33 (FIG. 6D).

Next, the second roller line R21 and R22 is moved in the positive direction of the X-axis and the standard DNA solution in the ingredient chamber i is squeezed out by the roller R22 to be moved to the ingredient chamber f (FIG. 6E). At this time, other flow paths that connect to the ingredient chamber f are blocked by other rollers such as the rollers R31 and R41 (FIG. 6D).

Meanwhile, the ingredient supplying chamber S is squeezed for a predetermined amount by the roller RS and the standard DNA solution in an amount according to the mixing ratio is filled in the ingredient chamber a (FIG. 6E).

Next, the third roller line R31 to R38 is moved in the negative direction of the X-axis and the standard DNA solution in the ingredient chamber f is squeezed out by the roller R31 to be moved in the ingredient chamber j, and then, the first roller line R11 to R18 is moved in the positive direction of the X-axis and the standard DNA solution in the ingredient chamber a is squeezed out by the roller R13 to be moved in the ingredient chamber i (FIG. 6F). Other flow paths are arbitrarily squeezed and blocked by other rollers.

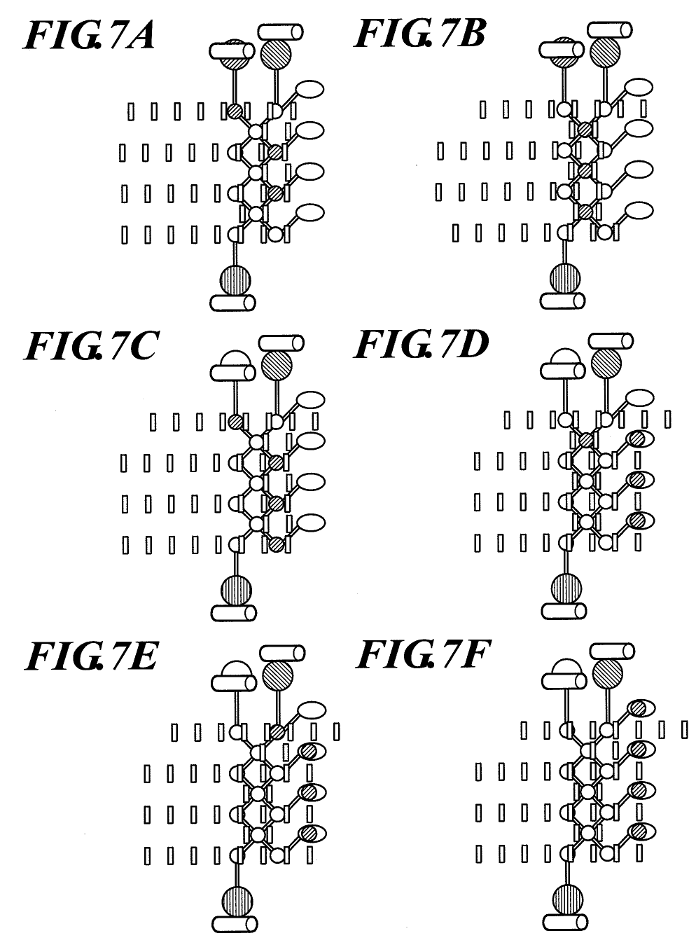

In the above manner, the standard DNA solution is distributed to each of the ingredient chambers f, g and h (FIG. 7A, 7B and 7C) and the standard DNA solution is filled in each of the mixing chambers M3, M4 and M5 respectively by the rollers R32, R52 and R72 (FIG. 7D). Later, the standard DNA solution is moved to the ingredient chamber e (FIG. 7C, 7D and 7E) and the standard DNA solution is filled in the mixing chamber M2 by the roller R14 (FIG. 7F).

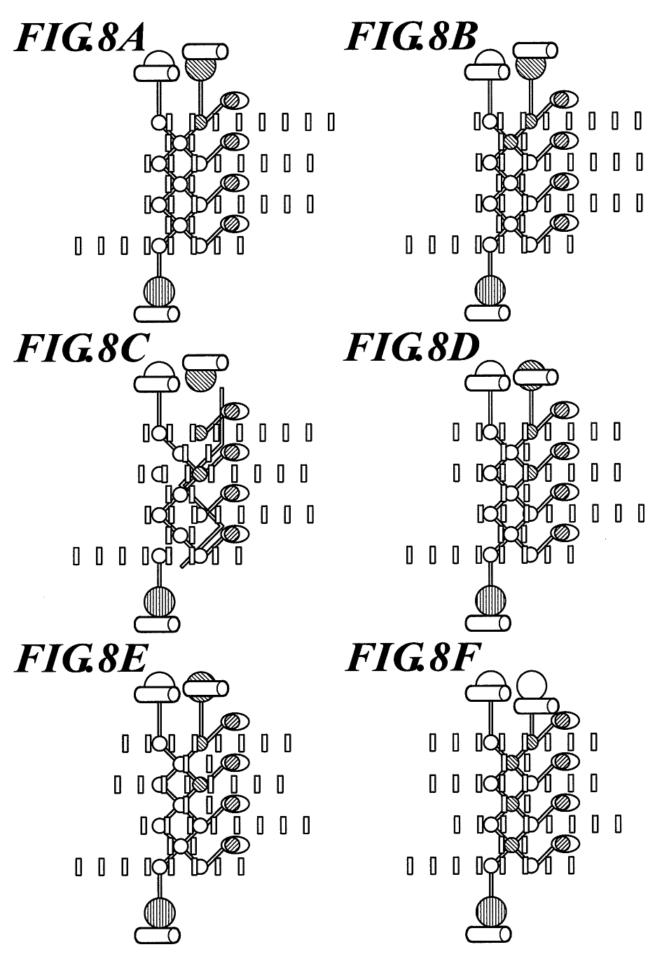

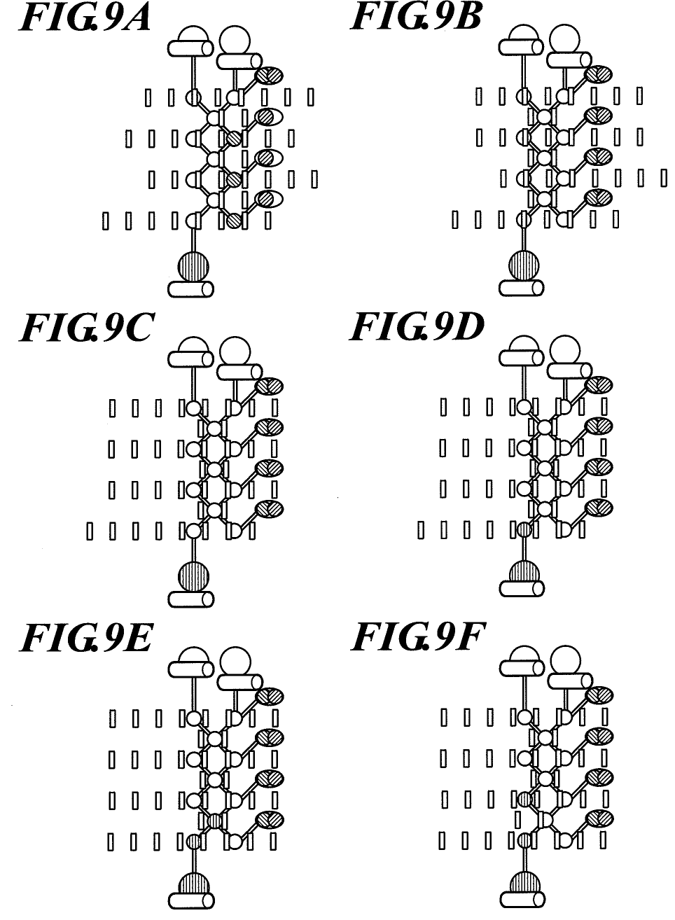

In a similar manner, the dilute solution is filled in the ingredient chamber e from the ingredient supplying chamber K for an amount according to the mixing ratio and the dilute solution is sent in the negative direction of the Y-axis via the flow path in the P direction and the flow path in the Q direction to be filled in each of the mixing chambers M3, M4 and M5 (FIGS. 8A to 8F and FIGS. 9A and 9B). Further, the dilute solution is filled in the ingredient chamber e from the ingredient supplying chamber K in an amount according to the mixing ratio and is directly filled in the mixing chamber M2 (FIG. 8F and FIG. 9A).

In a similar manner, the intercalator solution is filled in the ingredient chamber d from the ingredient supplying chamber I in an amount according to the mixing ratio and the intercalator solution is further sent in the positive direction of the Y-axis and in the positive direction of the X-axis via the flow path in the P direction and the flow path in the Q direction to be filled in each of the mixing chambers M2, M3 and M4. Furthermore, the intercalator solution filled in the ingredient chamber d is sent in the positive direction of X-axis via the flow path in the P direction and the flow path in the Q direction to be filled in the mixing chamber M5 (FIG. 9D to FIG. 11A).

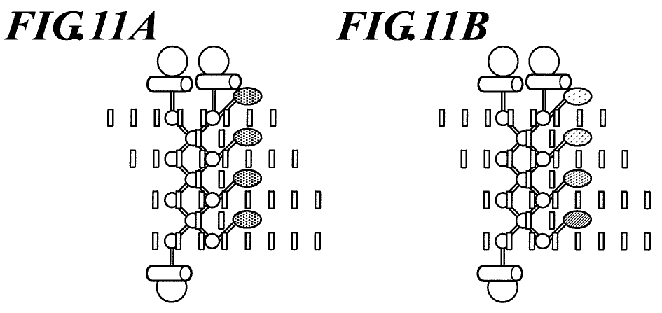

By the process described above, liquid mixtures in same amount having different mixing ratios are generated in the mixing chambers M2 to M5 (FIG. 11B). While facilitating the mixing by the rollers, oscillator or the like, the fluorescence amount is measured for the mixing chambers M2 to M5 by the fluorescence reader just after five minutes.

According to a first aspect of the preferred embodiments of the present invention, there is provided a chemical reaction cartridge comprising an elastic body as a construction material and a flow path and two or more chambers connected by the flow path formed inside the cartridge, and the cartridge is structured so as to move or block a fluid substance in the flow path or the chambers by partially sealing the flow path, the chambers or both the flow path and the chambers by applying external force to the elastic body from outside, as the chambers, the cartridge has two or more mixing chambers each of which is to contain a mixture in a fluid state, and the cartridge has two or more ingredient chambers provided for each of the mixing chambers by being connected with the flow path, in each of which an ingredient of the mixture divided in an amount according to a mixing ratio is to be contained.

Preferably, a volume of each one of the ingredient chambers is the amount according to the mixing ratio of the ingredient.

Preferably, a sum of volumes of the ingredient chambers connected to one of the mixing chambers is constant for all the mixing chambers, and a volume of each one of the ingredient chambers are different according to the mixing chambers.

Preferably, the chemical reaction cartridge further comprises an ingredient supplying chamber connected to one of the ingredient chambers belonging to one of the mixing chambers and another of the ingredient chambers belonging to another of the mixing chambers, in which the ingredient to be distributed to the ingredient chambers is contained.

Preferably, the chemical reaction cartridge further comprises two or more ingredient supplying chambers and a rigid substrate for maintaining a shape of a surface on which the flow path and the chambers are formed, and one of the ingredient supplying chambers and ingredient chambers connected to the one of the ingredient supplying chambers are formed on one surface side of the substrate, and another of the ingredient supplying chambers and ingredient chambers connected to the another of the ingredient supplying chambers are formed on the other surface side of the substrate.

Preferably, among the ingredient chambers formed on the one surface side of the substrate and the ingredient chambers formed on the other surface side of the substrate, either of the ingredient chambers are connected to one of the mixing chambers which is formed in a side of the substrate opposite from a side the ingredient chambers are formed by a hole which penetrates the substrate, and the other of the ingredient chambers are connected to the one of the mixing chambers by the flow path formed in a same side of the substrate as a side in which the one of the mixing chambers is formed.

Preferably, the chemical reaction cartridge further comprises two or more ingredient supplying chambers and the elastic body which forms the flow path and the chambers in a layer structure of two or more layers, and one of the ingredient supplying chambers and ingredient chambers connected to the one of the ingredient supplying chambers are formed in one layer of the elastic body, and another of the ingredient supplying chambers and ingredient chambers connected to the another of the ingredient supplying chambers are formed in another layer of the elastic body.

Preferably, among the ingredient chambers formed in the one layer of the elastic body and the ingredient chambers formed in the another layer of the elastic body, either of the ingredient chambers are connected to one of the mixing chambers which is formed in a same layer as a layer in which the other of the ingredient chambers are formed by a hole which penetrates the elastic body separating the one layer and the another layer, and the other of the ingredient chambers are connected to the one of the mixing chambers by the flow path formed in a same layer as a layer in which the one of the mixing chambers is formed.

Preferably, the ingredient chambers formed in the one layer of the elastic body and the ingredient chambers formed in the another layer of the elastic body are lead to one of the mixing chambers by a missing portion of the elastic body separating the one layer and the another layer.

According to a second aspect of the preferred embodiments of the present invention, there is provided a chemical reaction cartridge comprising an elastic body as a construction material and a flow path and two or more chambers connected by the flow path formed inside the cartridge, and the cartridge is structured so as to move or block a fluid substance in the flow path or the chambers by partially sealing the flow path, the chambers or both of the flow path and the chambers by applying external force to the elastic body from outside, as the chambers, the cartridge has two or more mixing chambers each of which is to contain a mixture, the cartridge has two or more ingredient supplying chambers each of which is to contain an ingredient of the mixture to be distributed to the mixing chambers, the cartridge has an ingredient chamber and the flow path to be commonly used by two or more ingredients, which connect between the two or more mixing chambers and the two or more ingredient supplying chambers, and the ingredient of the mixture is divided in an amount according to a mixing ratio and is to be contained in the ingredient chamber.

Preferably, the chemical reaction cartridge further comprises three or more ingredient chambers, and the ingredient chambers are connected via the flow path extending in each of two directions intersecting each other.

According to a third aspect of the preferred embodiments of the present invention, there is provided a mixture generating method using the chemical reaction cartridge comprising filling the ingredient in the amount according to the mixing ratio in each of the ingredient chambers and moving the ingredient in each of the two or more ingredient chambers to one of the mixing chambers by applying the external force to the elastic body to generate the mixture in which two or more ingredients are mixed, and the moving of the ingredient is carried out for the two or more mixing chambers.

According to a fourth aspect of the preferred embodiments of the present invention, there is provided a mixture generating method using the chemical reaction cartridge comprising first moving the ingredient in the amount according to the mixing ratio from the ingredient supplying chamber to each of the ingredient chambers by shrinking the ingredient supplying chamber for the amount according to the mixing ratio by applying the external force to the elastic body and second moving the ingredient contained in each of the two or more ingredient chambers to one of the mixing chambers by applying the external force to the elastic body to generate the mixture in which two or more ingredients are mixed, and the second moving is carried out for the two or more mixing chamber.

According to a fifth aspect of the preferred embodiments of the present invention, there is provided a mixture generating method using the chemical reaction cartridge comprising filling the ingredient in the amount according to the mixing ratio from the ingredient supplying chamber to each of the ingredient chambers at once by applying the external force to the elastic body and moving the ingredient contained in each of the two or more ingredient chambers to one of the mixing chambers by applying the external force to the elastic body to generate the mixture in which two or more ingredients are mixed, and the moving is carried out for the two or more mixing chambers, and the chemical reaction cartridge in which a volume of each of the ingredient chambers is the amount according to the mixing ratio is used.

According to a sixth aspect of the preferred embodiments of the present invention, there is provided a mixture generating method using the chemical reaction cartridge comprising first moving the ingredient in the amount according to the mixing ratio from the ingredient supplying chambers to each of the ingredient chambers by applying the external force to the elastic body by carrying out a time division for each ingredient and second moving the ingredient contained in each of the two or more ingredient chambers to each of the mixing chambers by applying the external force to the elastic body to generate a mixture in which two or more ingredients are mixed in each of the mixing chambers.

Preferably, mixtures having different mixing ratios are obtained in each of the ingredient chambers.

Preferably, the mixture generated by introducing each ingredient in one of the mixing chamber is moved back and forth between the one of the mixing chambers and a chamber which are connected by the flow path to facilitate a mixing.

Preferably, a vibration is transmitted to the mixture contained in the chambers to facilitate a mixing of the mixture.

Preferably, a mixing is carried out by carrying out an affairs adjustment.

According to a seventh aspect of the preferred embodiments of the present invention, there is provided a control device of a chemical reaction cartridge comprising the chemical reaction cartridge and pressing members for making the control device control a moving and a blocking of the liquid substance by applying the external force to the elastic body, and the pressing members are structured in a multiple-line structure where the pressing members move in a direction intersecting both of the two directions and are structured so as to move independently from other lines while maintaining a space between the pressing members for each line, and the ingredient in the amount according to the mixing ratio is moved to each of the mixing chambers by moving the ingredient via the flow path which extend in each of the two directions by the pressing members.

The entire disclosure of Japanese Patent Application No. 2008-052097 filed on Mar. 3, 2008 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A chemical reaction cartridge, comprising:
an elastic body as a construction material; and
a flow path and two or more chambers connected by the flow path formed inside the cartridge, wherein
the cartridge is structured so as to move or block a fluid substance in the flow path or the chambers by partially sealing the flow path, the chambers or both the flow path and the chambers by applying external force to the elastic body from outside,
as the chambers, the cartridge has two or more mixing chambers each of which is to contain a mixture in a fluid state, and
the cartridge has two or more ingredient chambers provided for each of the mixing chambers by being connected with the flow path, in each of which an ingredient of the mixture divided in an amount according to a mixing ratio is to be contained.

2. The chemical reaction cartridge as claimed in claim 1, wherein a volume of each one of the ingredient chambers is the amount according to the mixing ratio of the ingredient.

3. The chemical reaction cartridge as claimed in claim 1, wherein a sum of volumes of the ingredient chambers connected to one of the mixing chambers is constant for all the mixing chambers, and a volume of each one of the ingredient chamber is different according to the mixing chambers.

4. The chemical reaction cartridge as claimed in claim 1, further comprising an ingredient supplying chamber connected to one of the ingredient chambers belonging to one of the mixing chambers and another of the ingredient chambers belonging to another of the mixing chambers, in which the ingredient to be distributed to the ingredient chambers is contained.

5. The chemical reaction cartridge as claimed in claim 4, further comprising:
two or more ingredient supplying chambers; and
a rigid substrate for maintaining a shape of a surface on which the flow path and the chambers are formed, wherein
one of the ingredient supplying chambers and ingredient chambers connected to the one of the ingredient supplying chambers are formed on one surface side of the substrate, and
another of the ingredient supplying chambers and ingredient chambers connected to the another of the ingredient supplying chambers are formed on the other surface side of the substrate.

6. The chemical reaction cartridge as claimed in claim 5, wherein among the ingredient chambers formed on the one surface side of the substrate and the ingredient chambers formed on the other surface side of the substrate, either of the ingredient chambers are connected to one of the mixing chambers which is formed in a side of the substrate opposite from a side the ingredient chambers are formed by a hole which penetrates the substrate, and the other of the ingredient chambers are connected to the one of the mixing chambers by the flow path formed in a same side of the substrate as a side in which the one of the mixing chambers is formed.

7. The chemical reaction cartridge as claimed in claim 4, comprising:
two or more ingredient supplying chambers; and
the elastic body which forms the flow path and the chambers in a layer structure of two or more layers, wherein
one of the ingredient supplying chambers and ingredient chambers connected to the one of the ingredient supplying chambers are formed in one layer of the elastic body, and
another of the ingredient supplying chambers and ingredient chambers connected to the another of the ingredient supplying chambers are formed in another layer of the elastic body.

8. The chemical reaction cartridge as claimed in claim 7, wherein among the ingredient chambers formed in the one layer of the elastic body and the ingredient chambers formed in the another layer of the elastic body, either of the ingredient chambers are connected to one of the mixing chambers which is formed in a same layer as a layer in which the other of the ingredient chambers are formed by a hole which penetrates the elastic body separating the one layer and the another layer, and the other of the ingredient chambers are connected to the one of the mixing chambers by the flow path formed in a same layer as a layer in which the one of the mixing chambers is formed.

9. The chemical reaction cartridge as claimed in claim 7, wherein the ingredient chambers formed in the one layer of the elastic body and the ingredient chambers formed in the another layer of the elastic body are lead to one of the mixing chambers by a missing portion of the elastic body separating the one layer and the another layer.

10. A chemical reaction cartridge, comprising:
an elastic body as a construction material; and
a flow path and two or more chambers connected by the flow path formed inside the cartridge, wherein
the cartridge is structured so as to move or block a fluid substance in the flow path or the chambers by partially sealing the flow path, the chambers or both of the flow path and the chambers by applying external force to the elastic body from outside,
as the chambers, the cartridge has two or more mixing chambers each of which is to contain a mixture,
the cartridge has two or more ingredient supplying chambers each of which is to contain an ingredient of the mixture to be distributed to the mixing chambers,
the cartridge has an ingredient chamber and the flow path to be commonly used by two or more ingredients, which connect between the two or more mixing chambers and the two or more ingredient supplying chambers, and
the ingredient of the mixture is divided in an amount according to a mixing ratio and is to be contained in the ingredient chamber.

11. The chemical reaction cartridge as claimed in claim 10, further comprising:
three or more ingredient chambers, wherein
the ingredient chambers are connected via the flow path extending in each of two directions intersecting each other.

12. A mixture generating method using the chemical reaction cartridge as claimed in claim 1, comprising:
filling the ingredient in the amount according to the mixing ratio in each of the ingredient chambers; and
moving the ingredient in each of the two or more ingredient chambers to one of the mixing chambers by applying the external force to the elastic body to generate the mixture in which two or more ingredients are mixed, wherein
the moving of the ingredient is carried out for the two or more mixing chambers.

13. A mixture generating method using the chemical reaction cartridge as claimed in claim 4, comprising:
first moving the ingredient in the amount according to the mixing ratio from the ingredient supplying chamber to each of the ingredient chambers by shrinking the ingredient supplying chamber for the amount according to the mixing ratio by applying the external force to the elastic body; and
second moving the ingredient contained in each of the two or more ingredient chambers to one of the mixing chambers by applying the external force to the elastic body to generate the mixture in which two or more ingredients are mixed, wherein
the second moving is carried out for the two or more mixing chamber.

14. A mixture generating method using the chemical reaction cartridge as claimed in claim 4, comprising:
filling the ingredient in the amount according to the mixing ratio from the ingredient supplying chamber to each of the ingredient chambers at once by applying the external force to the elastic body; and
moving the ingredient contained in each of the two or more ingredient chambers to one of the mixing chambers by applying the external force to the elastic body to generate the mixture in which two or more ingredients are mixed, wherein
the moving is carried out for the two or more mixing chambers, and
the chemical reaction cartridge in which a volume of each of the ingredient chambers is the amount according to the mixing ratio is used.

15. A mixture generating method using the chemical reaction cartridge as claimed in claim 10, comprising:
first moving the ingredient in the amount according to the mixing ratio from the ingredient supplying chambers to each of the ingredient chambers by applying the external force to the elastic body by carrying out a time division for each ingredient; and
second moving the ingredient contained in each of the two or more ingredient chambers to each of the mixing chambers by applying the external force to the elastic body to generate a mixture in which two or more ingredients are mixed in each of the mixing chambers.

16. The mixture generating method as claimed in claim 12, wherein mixtures having different mixing ratios are obtained in each of the ingredient chambers.

17. The mixture generating method as claimed in claim 12, wherein the mixture generated by introducing each ingredient in one of the mixing chamber is moved back and forth between the one of the mixing chambers and a chamber which are connected by the flow path to facilitate a mixing.

18. The mixture generating method as claimed in claim 12, wherein a vibration is transmitted to the mixture contained in the chambers to facilitate a mixing of the mixture.

19. The mixture generating method as claimed in claim 12, wherein a mixing is carried out by carrying out an affairs adjustment.

20. A control device of a chemical reaction cartridge, comprising:
the chemical reaction cartridge as claimed in claim 11; and
pressing members for making the control device control a moving and a blocking of the liquid substance by applying the external force to the elastic body, wherein
the pressing members are structured in a multiple-line structure where the pressing members move in a direction intersecting both of the two directions and are structured so as to move independently from other lines while maintaining a space between the pressing members for each line, and
the ingredient in the amount according to the mixing ratio is moved to each of the mixing chambers by moving the ingredient via the flow path which extend in each of the two directions by the pressing members.

21. The control device of the chemical reaction cartridge as claimed in claim 20, wherein the pressing members are squeegees, shutters or rollers.

22. The control device of the chemical reaction cartridge as claimed in claim 20, wherein the ingredient in one of the ingredient chambers is supplied to an arbitrary ingredient chamber among surrounding ingredient chambers by applying pressure to the one of the ingredient chambers to which the surrounding ingredient chambers are connected via the flow path in four directions along the two directions by the pressing members.

23. The chemical reaction cartridge as claimed in claim 1, further comprising a structure to cleanse the flow path and the ingredient chambers in which the ingredient has once passed through.

24. The chemical reaction cartridge as claimed in claim 1, further comprising a window having an optical transparency to detect a light quantity of a product in the chambers or the flow path.

25. The chemical reaction cartridge as claimed in claim 1, wherein a dilution series of a nucleic acid solution is prepared.

26. The mixture generating method as claimed in claim 12, wherein a dilution series of a nucleic acid solution is prepared.

27. The control device of the chemical reaction cartridge as claimed in claim 20, wherein a dilution series of a nucleic acid solution is prepared.
